(19) United States
(12) Patent Application Publication
(10) Pub. No.: US 2018/0092334 A1
(43) Pub. Date: Apr. 5, 2018

(54) WALK N ROLL RETRACTABLE LEASH FOR A PET

(71) Applicant: Anne T. Weise, Greenfield, WI (US)

(72) Inventor: Anne T. Weise, Greenfield, WI (US)

(21) Appl. No.: 15/283,661

(22) Filed: Oct. 3, 2016

(51) Int. Cl. A01K 27/00

(52) U.S. Cl. CPC A01K 27/008; A01K 27/004

(57) ABSTRACT

An apparatus with a roll of one or more pick-up bags for a pet includes: (i) a handle, (ii) a push button, (iii) a roll of one or more plastic pick-up bags, (iv) a plastic housing (v) a nylon leash, (vi) a nylon cord, and (vii) a leash lock. The user holds the pet leash apparatus using the handle. The plastic housing includes: (i) a cavity, (ii) a snap, and (iii) a metal rod. The cavity encloses the roll of one or more plastic pick-up bags. The snap locks to the metal rod. The nylon cord attaches to the leash. The nylon leash is attached to the collar of the pet using the metal clasp. The nylon leash is retractable. The leash lock allows the user to lock or release the cord when the user presses the push button.

### BACKGROUND

### Technical Field

The embodiment herein generally relates to a retractable leash for a pet, and more particularly to the retractable dog leash with a roll of one or more pick-up bags.

### Description of the Related Art

A pet is considered as the best friend of human beings. Roaming and playing with the pet has become a favorite pastime for most of the pet lovers. An owner of the pet generally attaches a leash to the pet's collar for keeping the pet nearby during an outdoor visit. The pet excretion during the outdoor visit or during a walk has always been a serious issue. The owner may sometimes forget to carry a pick-up bag for waste. The owner must then return home to retrieve a bag which is a time consuming and annoying task.

A typical leash apparatus includes a conventional leash to attach to the collar over the neck of the pet. A conventional leash apparatus does not include a dispenser with the leash apparatus. The owner cannot retract the leash back into the leash apparatus, which leads to a great mess.

The present invention provides an easy to hold, simple, effective retractable dog leash with a roll of pick-up bags.

### SUMMARY

In view of the foregoing, an embodiment herein provides an apparatus with a roll of one or more pick-up bags for a pet. The apparatus include: (i) a handle, (ii) a push button (iii) a roll of one or more pick-up bags, (iv) a housing, (v) a cord, (vi) a leash, and (vii) a leash lock. The handle is adapted to allow a user to hold the apparatus. The push button allows a user to release the lock. The housing includes (i) a cavity, (ii) a snap, and (iii) a rod. The cavity is adapted to enclose the roll of one or more pick-up bags. The rod is adapted to hold the roll of one or more pick-up bags. The snap is adapted to lock the rod. The cord is adapted to retract and coils in the housing. The leash is attached to the cord. The leash is adapted to be attached to a collar of the pet using a clasp. The leash lock is adapted to allow the user to lock or release the cord when the user presses the push button.

In one embodiment, the roll of one or more pick-up bags is made from a material selected from a group of plastic, paper or cloth. In another embodiment, the housing is made from plastic. In another embodiment, the leash is made from nylon. The rod is made of metal. In another embodiment, the cord is made from nylon. In yet another aspect, the cord is retractable.

In another aspect, an embodiment herein provides an apparatus with a roll of one or more pick-up bags for a pet. The apparatus include: (i) a handle, (ii) a push button (iii) a roll of one or more pick-up bags, (iv) a housing, (v) a nylon cord, (vi) a nylon leash, and (vii) a leash lock. The handle is adapted to allow a user to hold the apparatus. The push button allows a user to release the lock. The housing includes (i) a cavity, (ii) a snap, and (iii) a rod. The cavity is adapted to enclose the roll of one or more pick-up bags. The metal rod is adapted to hold the roll of one or more pick-up bags. The snap is adapted to lock the metal rod. The nylon cord is adapted to retract and coils in the housing. The leash is attached to the nylon cord. The nylon leash is adapted to be attached to a collar of the pet using a metal clasp. The leash lock is adapted to allow the user to lock or release the nylon cord when the user presses the push button.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof and the embodiments herein include all such modifications.

### BRIEF DESCRIPTION OF THE DRAWINGS

The embodiments herein will be better understood from the following detailed description with reference to the drawings, in which:

FIG. 1 is a diagrammatic representation of an apparatus with a roll of one or more pick-up bags according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need of a safe, cheap and a retractable pet leash with a roll of one or more pick-up bags.

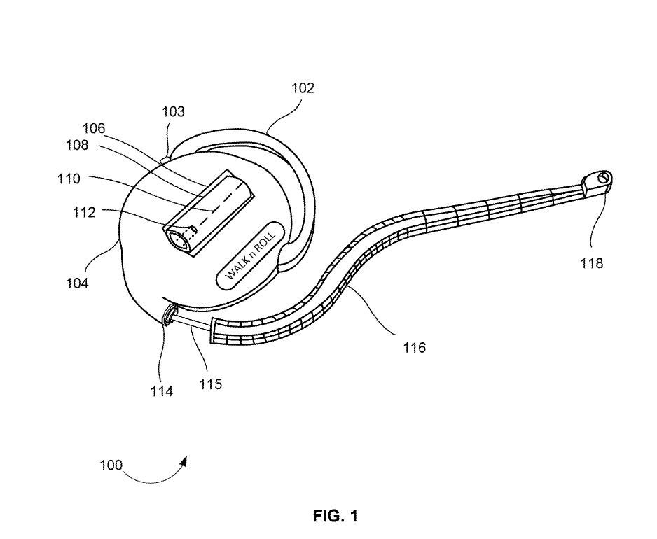

FIG. 1 is a diagrammatic representation of an apparatus with a leash and a roll of one or more pick-up bags, according to an embodiment herein. The pet leash apparatus 100 includes a handle 102, a push button 103, a housing 104, a cavity 106, the roll of one or more pick-up bags 108, a rod 110, a snap 112, a leash lock 114, a cord 115, the leash 116, and a clasp 118. A user holds the pet leash apparatus 100 from the handle 102. The handle 102 couples to a housing 104. The housing 104 encloses a recoil system and a retractable mechanism (not shown in FIG. 1). The top of the housing 104 includes the push button 103 that operates the leash lock 114. The housing 104 further includes the cavity 106 for holding the roll of one or more pick-up bags 108. The cavity 106 holds the roll of one or more pick-up bags 108 with the rod 110 and the snap 112. The snap 112 of the pet leash apparatus 100 locks the rod 110. The rod 110 is hinged at one end with the cavity 106. The user removes/unlocks the snap 112 from the rod 110 to unmount the roll of one or more pick-up bags 108. The new roll of one or more pick-up bags 108 is mounted on the rod 110 and the user locks the snap 112 on the rod 110. In one embodiment, the rod 110 is a metal rod. The housing 104 also couples a leash lock 114. The leash lock 114 locks the cord 115 when the user presses the push button 103 first time. The housing 104 further includes a retraction mechanism to retract the cord 115 back into the housing 104 when the user presses the push button 103 second time. The cord 115 couples to the leash 116. The leash 116 includes a clasp 118 to be attached to the pet's collar. In one embodiment, the clasp 118 is a spring clasp. In another embodiment, the leash 116 is made from a material, including without limiting to, nylon. In another embodiment, the cord 115 is made from a material, including without limiting to, nylon. In another embodiment, the clasp 118 is made from, without limiting, metal.

The retraction mechanism allows an easy handling of the long leash in the pet leash apparatus. The user does not need to carry the pick-up bags separately. The nylon material of the leash increases the durability of the leash. The thick leash allows pulling heavy pets. The thin nylon cord allows the user to extend the leash to a large extent. The push button is provided to keep the pet on the desired length from the user. The pet leash apparatus includes the roll of one or more pick-up bags. The rod is hinged to one end, so as to remove and mount new roll of one or more pick-up bags conveniently.

The foregoing description of the specific embodiments will fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An apparatus with a roll of one or more pick-up bags for a pet comprises:
a handle that is adapted to allow a user to hold said apparatus using said handle, wherein said handle comprises:
a push button;
a roll of one or more pick-up bags;
a housing, wherein said housing comprises:
a cavity that is adapted to enclose said roll of one or more pick-up bags;
a rod that is adapted to hold said roll of one or more pick-up bags; and
a snap that is adapted to lock said rod;
a cord that is adapted to retract in said housing;
a leash that is adapted to be attached to a collar of said pet using a clasp; and
a leash lock that is adapted to allow said user to lock or release said cord when said user presses said push button.

2. The apparatus of claim 1, wherein said roll or one or more pick-up bags is made from a material selected from a group of plastic, paper or cloth.

3. The apparatus of claim 1, wherein said housing is made from plastic.

4. The apparatus of claim 1, wherein said rod is made from metal.

5. The apparatus of claim 1, wherein said leash and said cord are made from nylon.

6. The apparatus of claim 1, wherein said cord is retractable.

7. The apparatus of claim 1, wherein said clasp is made from metal.

8. An apparatus with a roll of one or more pick-up bags for a pet comprises:
a handle that is adapted to allow a user to hold said apparatus using said handle, wherein said handle comprises:
a push button;
a roll of one or more plastic pick-up bags;
a plastic housing, wherein said plastic housing comprises:
a cavity that is adapted to enclose said roll of one or more plastic pick-up bags;
a metal rod that is adapted to hold said roll of one or more plastic pick-up bags; and
a snap that is adapted to lock said metal rod;
a nylon cord that is adapted to retract in said housing;
a nylon leash that is adapted to be attached to a collar of said pet using a metal clasp;
a leash lock that is adapted to allow said user to lock or release said cord when said user presses said push button.

9. The apparatus claim 8, wherein the nylon cord is retractable.
